(19) United States
(12) Patent Application Publication
(10) Pub. No.: US 2023/0067132 A1
(43) Pub. Date: Mar. 2, 2023

(54) SIGNAL PROCESSING DEVICE, SIGNAL PROCESSING METHOD, AND SIGNAL PROCESSING PROGRAM

(71) Applicant: NIPPON TELEGRAPH AND TELEPHONE CORPORATION, Tokyo (JP)

(72) Inventors: Tsubasa OCHIAI, Musashino-shi, Tokyo (JP); Marc DELCROIX, Musashino-shi, Tokyo (JP); Rintaro IKESHITA, Musashino-shi, Tokyo (JP); Keisuke KINOSHITA, Musashino-shi, Tokyo (JP); Tomohiro NAKATANI, Musashino-shi, Tokyo (JP); Shoko ARAKI, Musashino-shi, Tokyo (JP)

(73) Assignee: NIPPON TELEGRAPH AND TELEPHONE CORPORATION, Tokyo (JP)

(21) Appl. No.: 17/794,266

(22) PCT Filed: Feb. 14, 2020
(86) PCT No.: PCT/JP2020/005913

§ 371 Date: Jul. 21, 2022

(51) Int. Cl. G10L 21/0272; H04R 3/00; G10L 25/93

(52) U.S. Cl. CPC G10L 21/0272; H04R 3/005; G10L 25/93; G10L 2025/937

(57) ABSTRACT

A signal processing apparatus includes a neural network (“NN”), a sorting unit, and a spatial covariance matrix calculation unit. The NN converts a mixed signal, in which sounds of a plurality of sound sources input by a plurality of channels are mixed, into a separated signal separated into a signal for each sound source as a signal in a time domain as it is and outputs the separated signal. The sorting unit sorts, for the separated signal of each channel output from the NN, the separated signal of each channel such that the plurality of sound sources of a plurality of the separated signals are aligned among the plurality of channels. The spatial covariance matrix calculation unit calculates a spatial covariance matrix corresponding to each sound source in accordance with the separated signal for each channel output from the sorting unit and sorted.

### TECHNICAL FIELD

The present invention relates to a signal processing apparatus, a signal processing method, and a signal processing program.

### BACKGROUND ART

A neural beamformer has been known as a technique for extracting sound of a specific sound source from a mixed acoustic signal by using a neural network. The neural beamformer has been attracting attention as a technique that plays an important role in speech recognition and the like of mixed speech. Although an estimation of a spatial covariance matrix is important in a design of the beamformer, a technique for estimating a spatial covariance matrix via a mask estimated by using a neural network (hereinafter, abbreviated as an NN as appropriate) has been widely used (see NPL 1).

### CITATION LIST

### Non Patent Literature

NPL 1: Jahn Heymann, Lukas Drude, and Reinhold Haeb-Umbach, “NEURAL NETWORK BASED SPECTRAL MASK ESTIMATION FOR ACOUSTIC BEAMFORMING” in IEEE International Conference on Acoustics, Speech and Signal Processing (ICASSP), 2016, pp. 96-200.

### SUMMARY OF THE INVENTION

### Technical Problem

Here, it is conceivable that an ideal estimated value of a covariance matrix is calculated by using a true signal of a target sound source. In the technique as in NPL 1, in addition to an estimation error of a mask by an NN, an estimation error of a spatial covariance matrix via the mask is also added. Accordingly, a difference occurs between the spatial covariance matrix obtained by calculation and an ideal form of the spatial covariance matrix, and thus there is still room for improvement in performance of a beamformer that uses an estimated spatial covariance matrix. Thus, an object of the present invention is to accurately estimate a spatial covariance matrix that improves performance of a beamformer.

### Means for Solving the Problem

To solve the problem described above, the present invention includes a neural network that converts a mixed signal, in which sounds of a plurality of sound sources input by a plurality of channels are mixed, into a separated signal separated into a signal for each sound source as a signal in a time domain as it is and outputs the separated signal, a sorting unit that sorts, for the separated signal of each channel output from the neural network, the separated signal of each channel such that the plurality of sound sources of a plurality of the separated signals are aligned among the plurality of channels, and a spatial covariance matrix calculation unit that calculates a spatial covariance matrix corresponding to each sound source in accordance with the separated signal for each channel output from the sorting unit and sorted.

### Effects of the Invention

The present invention can accurately estimate a spatial covariance matrix that improves performance of a beamformer.

### BRIEF DESCRIPTION OF DRAWINGS

FIG. 1 is a diagram illustrating a configuration example of a signal processing apparatus according to a first embodiment.

FIG. 2 is a flowchart illustrating an example of a processing procedure of the signal processing apparatus illustrated in FIG. 1.

FIG. 3 is a diagram illustrating a configuration example of a signal processing apparatus according to a second embodiment.

FIG. 4 is a diagram for explaining an output correction unit in FIG. 3.

FIG. 5 is a diagram illustrating a configuration example of a computer that executes a signal processing program.

### DESCRIPTION OF EMBODIMENTS

Hereinafter, modes for carrying out the present invention (embodiments), which include a first embodiment and a second embodiment, will be separately described with reference to the drawings. Note that the present invention is not limited to the embodiments described below.

Overview

First, an overview of a signal processing apparatus of each embodiment according to the present invention will be described. Conventionally, in a design of a beamformer that extracts sound of a specific sound source from a mixed speech signal, an estimation of a spatial covariance matrix via a mask assumes sparsity of a signal (for example, that only one signal at most is present at a certain time frequency bin). Thus, at a place where the assumption does not hold true, no matter how accurate a mask can be estimated, a spatial covariance matrix obtained via the mask does not match a spatial covariance matrix calculated by using a true signal without the mask. As a result, a performance upper limit that can be achieved by the beamformer tends to be lower.

Thus, the signal processing apparatus of each embodiment according to the present invention estimates a spatial covariance matrix without a mask by using an NN that directly estimates a signal in a time domain of a target speaker. In this way, the signal processing apparatus estimates a spatial covariance matrix without a mask, and can thus improve a performance upper limit that can be achieved by the beamformer. Further, the NN that directly estimates a signal in a time domain operates with extremely higher performance than that of the NN that estimates a signal via a mask in a conventional manner. As a result, the signal processing apparatus can accurately estimate a spatial covariance matrix that improves the performance of the beamformer.

### First Embodiment

### Configuration Example

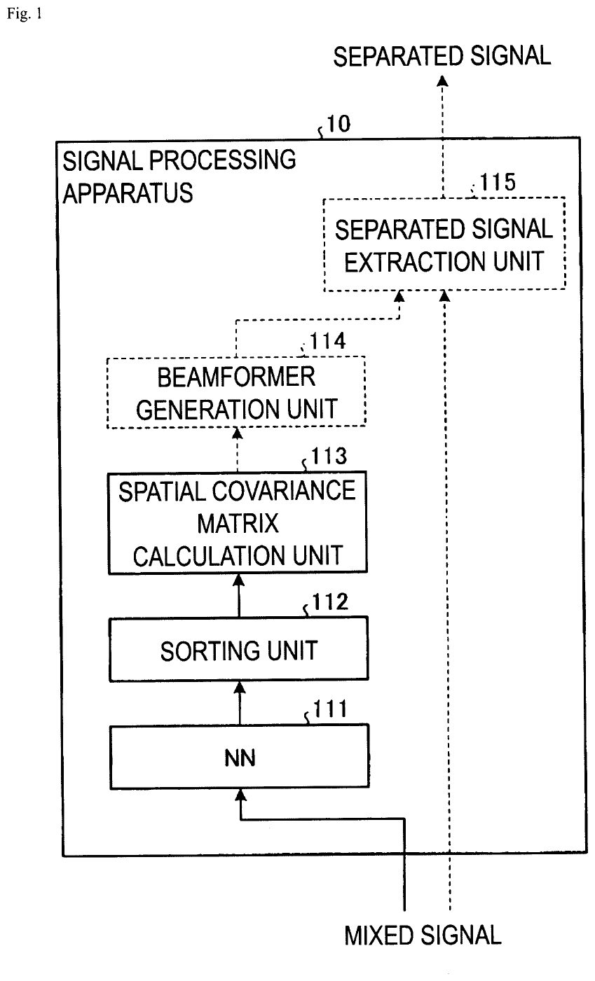

A configuration example of a signal processing apparatus 10 according to a first embodiment will be described with reference to FIG. 1. The signal processing apparatus 10 includes an NN 111, a sorting unit 112, and a spatial covariance matrix calculation unit 113. A beamformer generation unit 114 and a separated signal extraction unit 115 indicated by a broken line may not be provided or may be provided. A case where the beamformer generation unit 114 and the separated signal extraction unit 115 are provided will be described below.

The NN 111 is an NN trained to analyze a mixed signal (for example, a mixed speech signal) as a signal in a time domain as it is and separate the mixed signal into a signal for each sound source and output the signal. The NN 111 converts the input mixed signal in the time domain into a signal for each sound source, and outputs the signal. Note that TasNet (see Reference 1 below) has been known as a technique for separating a mixed signal of a single channel in a time domain.

Reference 1: Yi Luo and Nima Mesgarani, “Conv-TasNet: Surpassing ideal time-frequency magnitude masking for speech separation” IEEE/ACM Transactions on Audio, Speech, and Language Processing (TASLP), vol. 27, no. 8, pp. 1256-1266, 2019.

Here, the NN 111 needs to separate a mixed signal of a plurality of channels. Thus, for example, a technique in which TasNet described above is extended to the plurality of channels is used in the NN 111. For example, the signal processing apparatus 10 applies the NN 111 while repeatedly changing an input by the number of output channels. As a result, a signal separated for each sound source is obtained for each channel from the NN 111.

Note that the mixed signal here is a signal in which sounds of a plurality of sound sources are mixed. Here, the sound source may be a speaker, or may be sound generated by a device and the like or sound generated by a noise source. For example, sound in which speech of a speaker and noise are mixed is the mixed signal.

The sorting unit 112 integrates (arranges), into a multi-channel signal for each sound source, a separated signal that is output from the NN 111 and is separated for each channel and each sound source. The separated signal output from the NN 111 may vary in an order of a sound source for each channel. Thus, the sorting unit 112 sorts the separated signal output from the NN 111 such that an i-th sound source of a separated signal of each of the channels is the same sound source.

For example, the sorting unit 112 sorts a plurality of separated signals output from the NN 111 based on an equation (1) shown below.

$$\begin{matrix}[ Math . 1 ] & \\ {\hat{π}}_{c} = {argmax}_{{π}_{c}} {\sum }_{i = 1}^{I} x corr ( {\hat{x}}_{i , {c}_{ref}} , {\hat{x}}_{{π}_{c} ( i )} , c ) & Equation ( 1 )\end{matrix}$$

In the equation (1), πc={1, . . . , I}→{1, . . . , I} is a function of sorting an index of each sound source of a c-th channel, and c_{ref} represents a reference channel (a channel as a reference). The function of sorting the index is determined to be π_{c} such that an index of a separated signal in a target channel (the c-th channel) having a maximum degree of similarity (a value of a cross-correlation function) with a separated signal corresponding to an i-th sound source in the reference channel is i.

The spatial covariance matrix calculation unit 113 estimates (calculates) a spatial covariance matrix corresponding to each of the sound sources based on the separated signal for each channel being output from the sorting unit 112, and outputs the spatial covariance matrix.

For example, the spatial covariance matrix calculation unit 113 calculates a spatial covariance matrix Φ^{S1} corresponding to an i-th sound source Sᵢ and a spatial covariance matrix Φ^{Ni} corresponding to an i-th noise source Nᵢ by using an equation (2) and an equation (3) below.

$$\begin{matrix}[ Math . 2 ] & \\ {Φ}_{f}^{{S}_{i}} = \frac{1}{T} {\sum }_{t = 1}^{T} {\hat{X}}_{i , t , f} {\hat{X}}_{i , t , f}^{H} & Equation ( 2 )\end{matrix}$$

$${Φ}_{f}^{{N}_{i}} = \frac{1}{T} {\sum }_{t = 1}^{T} ( {Y}_{t , f} - {\hat{X}}_{i , t , f} ) {( {Y}_{t , f} - {\hat{X}}_{i , t , f} )}^{H} \qquad Equation ( 3 )$$

Here, \hat{ }X_{i, t, f} in the equations (2) and (3) is a vector that is obtained by converting a separated signal of the i-th sound source of each of the channels being output from the sorting unit 112

{\hat{x}_{i,c}}_{c=1}^{C} [Math. 3]

by short-time Fourier transform (STFT) and that includes an STFT coefficient arranged in a time frequency bin (t,f). Note that a symbol \hat{ } in \hat{ }X_{i, t, f} is originally displayed on a subsequent variable X, but is written immediately before the variable X for convenience of display in the text. Further, Y_{t, f} in the equation (3) is a vector that is obtained by converting an input mixed signal by STFT and that includes an STFT coefficient arranged in the time frequency bin (t,

Such a signal processing apparatus 10 can estimate a spatial covariance matrix without a mask. As a result, the signal processing apparatus 10 can obtain the spatial covariance matrix that is more accurate (that is closer to an ideal spatial covariance matrix) than a conventional spatial covariance matrix.

Note that the signal processing apparatus 10 described above may include the beamformer generation unit 114 and the separated signal extraction unit 115 indicated by the broken line in FIG. 1.

The beamformer generation unit 114 calculates a filter coefficient we of a time-invariant beamformer based on the spatial covariance matrix (Tr) output by the spatial covariance matrix calculation unit 113. For example, the beamformer generation unit 114 calculates the filter coefficient w_{f} by using an equation (4) below.

$$\begin{matrix}[ Math . 4 ] & \\ {w}_{f} = \frac{{( {Φ}_{f}^{N} )}^{- 1} {Φ}_{f}^{S}}{Tr ( {( {Φ}_{f}^{N} )}^{- 1} {Φ}_{f}^{S} )} u & Equation ( 4 )\end{matrix}$$

The separated signal extraction unit 115 applies, to the input mixed signal, beam forming using the filter coefficient we calculated by the beamformer generation unit 114 to extract a separated signal in a time domain in which the input mixed signal is separated for each sound source.

For example, the separated signal extraction unit 115 calculates an SIFT coefficient of a separated signal by an equation (5) below, and inversely converts the SIFT coefficient to obtain and output the separated signal in the time domain.

\hat{X}_{t, f}^{BF}=w_{f}^{H}Y_{t, f} [Math. 5]

As described above, the signal processing apparatus 10 can accurately extract the separated signal from the mixed signal.

Example of Processing Procedure

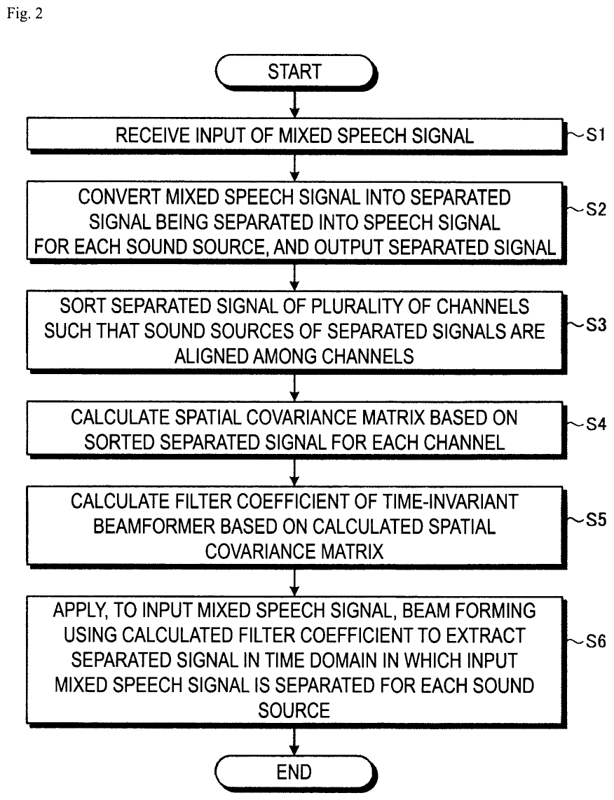

Next, an example of a processing procedure of the signal processing apparatus 10 described above will be described with reference to FIG. 2. Note that it is assumed that the signal processing apparatus 10 includes the beamformer generation unit 114 and the separated signal extraction unit 115. Further, a case where an input mixed signal is a mixed speech signal of a plurality of speakers will be described as an example.

For example, when the NN 111 of the signal processing apparatus 10 receives an input of the mixed speech signal of the plurality of channels (S1), the NN 111 converts the mixed speech signal received in S1 into a separated signal being separated into a speech signal for each sound source, and outputs the separated signal (S2).

After S2, the sorting unit 112 sorts the separated signal of the plurality of channels output from the NN 111 in S2 such that a sequence of the sound source of the separated signal is the same between the channels (S3). Subsequently, the spatial covariance matrix calculation unit 113 calculates a spatial covariance matrix based on the separated signal for each of the channels being sorted in S3 (S4).

After S4, the beamformer generation unit 114 calculates a filter coefficient of a time-invariant beamformer based on the spatial covariance matrix calculated in S4 (S5).

After S5, when the separated signal extraction unit 115 receives an input of the mixed speech signal, the separated signal extraction unit 115 applies, to the input speech signal, beam forming using the filter coefficient calculated in S5 to extract a separated signal in a time domain in which the input mixed speech signal is separated for each sound source (S6).

In this way, the signal processing apparatus 10 can estimate an accurate spatial covariance matrix (close to an ideal spatial covariance matrix). As a result, the signal processing apparatus 10 can accurately extract a separated signal from a mixed speech signal by the beamformer.

### Second Embodiment

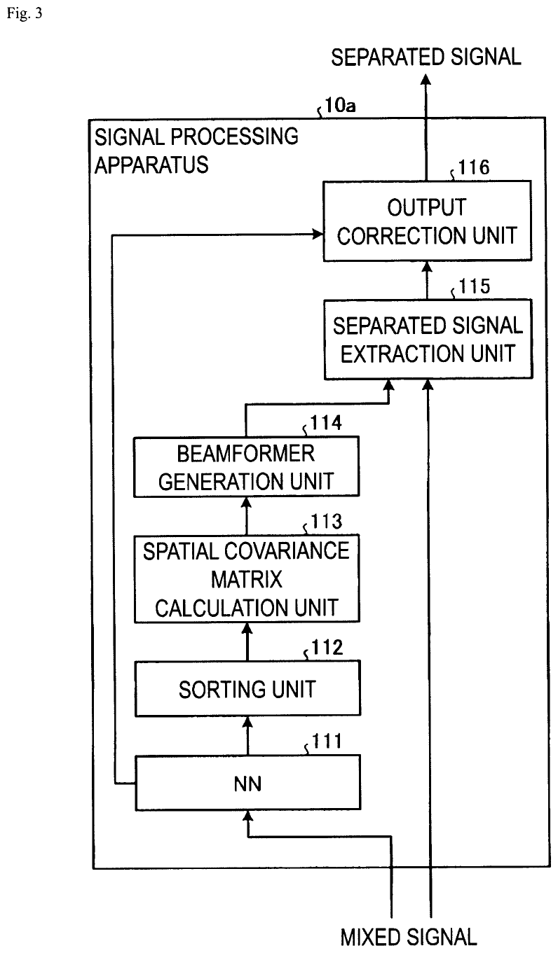

Next, a second embodiment of the present invention will be described with reference to FIG. 3. Configurations that are the same as those in the first embodiment are denoted with the same reference signs, and the description thereof will be omitted.

A separated signal obtained by the separated signal extraction unit 115 of the signal processing apparatus 10 is basically more accurate than a separated signal obtained by the NN 111. However, for example, when the number of microphones used in obtaining a mixed signal is limited, or when there is an error in a spatial covariance matrix calculated by the spatial covariance matrix calculation unit 113, a separated signal to be output may include many influences of sound (noise) of another sound source. Then, when the separated signal including the noise is used for speech recognition and the like, the noise may particularly greatly affect a silent section and may adversely affect recognition accuracy.

In order to solve such a problem, a signal processing apparatus 10a according to the second embodiment creates mask information based on a separated signal output from an NN 111 and uses the mask information to correct a separated signal output by a separated signal extraction unit 115.

A configuration example of the signal processing apparatus 10a will be described with reference to FIG. 3. As illustrated in FIG. 3, the signal processing apparatus 10a further includes an output correction unit 116.

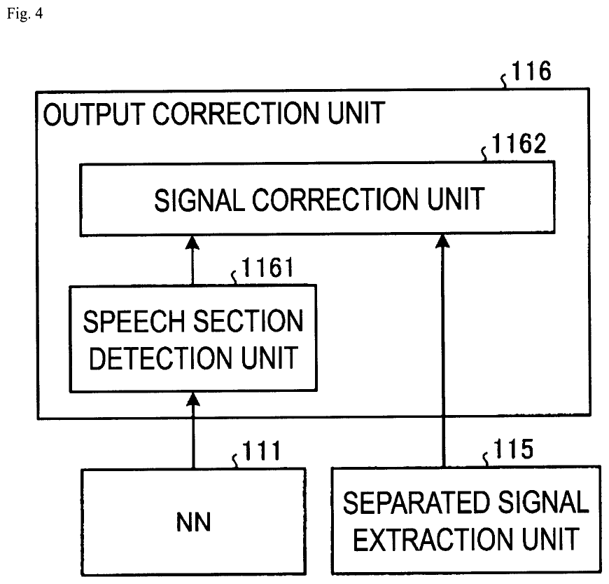

The output correction unit 116 performs processing of removing an influence of noise and the like from a separated signal extracted by the separated signal extraction unit 115, and improving an output signal. The output correction unit 116 will be described in detail with reference to FIG. 4. Note that, in FIG. 4, description of a configuration other than the NN 111, the separated signal extraction unit 115, and the output correction unit 116 of the signal processing apparatus 10a is omitted.

For example, the output correction unit 116 includes a speech section detection unit (a mask information creation unit) 1161 and a signal correction unit 1162.

The speech section detection unit 1161 sets, as an input, one (a reference signal) of separated signals of a multi-channel output from the NN 111, and performs speech section detection (voice activity detection (VAD)). A well-known speech section detection technique (for example, Reference 2) may be used for the speech section detection. The speech section detection unit 1161 performs the speech section detection described above to create and output mask information (a VAD mask) for extracting a signal corresponding to a speech section from the separated signal output from the NN 111.

Reference 2: J. Sohn, N. S. Kim, and W. Sung, “A Statistical Model-Based Voice Activity Detection” IEEE Signal Process. Lett., vol. 6, no. 1, pp. 1-3, 1999.

The signal correction unit 1162 applies the mask information output from the speech section detection unit 1161 to the separated signal output from the separated signal extraction unit 115 to obtain a signal leaving the signal corresponding to the speech section from the separated signal and output the obtained signal.

For example, provided that a VAD mask corresponding to a signal of a certain frame τ is m_{vad}(τ) and a separated signal of a mixed signal of the frame τ output from the separated signal extraction unit 115 is x the signal correction unit 1162 obtains a signal x_{refine}(τ) after a correction by an equation (6) below, and outputs the signal x_{refine}(τ). Note that, in the equation (6), it is assumed that a value of the signal is 0 in a section set as a silent section by the VAD.

[Math. 6]

x_{refine}(τ)=m_{vad}(τ)x_{mvdr}(τ) Equation (6)

Further, for example, based on an equation (7) below, the signal correction unit 1162 may output a separated signal output from the separated signal extraction unit 115 as it is in a time frame in which the VAD mask described above is 1 (that is, a time frame corresponding to the speech section) and may output a separated signal (xₜₐₛₙₑₜ(τ)) output from the NN 111 in a time frame in which the VAD mask is 0 (that is, a time frame corresponding to the silent section).

$$\begin{matrix}[ Math . 7 ] & \\ {x}_{refine} ( τ ) = \{ \begin{matrix}{x}_{mvdr} ( τ ) & ( {m}_{v a d} ( τ ) = 1 ) \\ {x}_{tasnet} ( τ ) & ( {m}_{v a d} ( τ ) = 0 )\end{matrix} & Equation ( 7 )\end{matrix}$$

In other words, when the noise is included, the signal correction unit 1162 may use an output of the NN 111 as it is in the silent section that may affect subsequent processing and may output the separated signal output from the separated signal extraction unit 115 in the speech section. In this way, the signal processing apparatus 10a can output an accurate separated signal regardless of the number of microphones used in an input mixed signal and whether a mixed signal includes a silent section.

Experimental Results

An evaluation result when the signal correction unit 1162 of the signal processing apparatus 10a outputs a separated signal based on the equation (7) described above is illustrated in Table 1 below. Note that the present experiment was evaluated by using WSJ0-2mix corpus.

TABLE 1

| Method | # CH in BF | SDR | WER |
|---|---|---|---|
| Oracle mask-MVDR | 2 | 13.3 | 18.5 |
| | 4 | 14.0 | 7.1 |
| TasNet (1ch) | — | 11.3 | 23.5 |
| MC-TasNet (2ch) | — | 12.7 | 18.1 |
| MC-TasNet (4ch) | — | 12.1 | 20.3 |
| Proposed Beam-TasNet (1ch) | 2 | 12.9 | 15.6 |
| (* using TasNet (1ch)) | 4 | 15.8 | 9.9 |
| Proposed Beam-TasNet (2ch) | 2 | 13.8 | 12.5 |
| (* using MC-TasNet (2ch)) | 4 | 16.8 | 7.1 |

#CH in BF in Table 1 is the number of channels processed by a beamformer of the signal processing apparatus 10a. Proposed Beam-TasNet (1 ch) corresponds to a case where TasNet of 1 ch is used in the NN 111 in the signal processing apparatus 10a. Further, Proposed Beam-TasNet (2 ch) corresponds to a case where TasNet of 1 ch is used in the NN 111 in the signal processing apparatus 10a. A signal to distortion ratio (SDR) and a word error rate (WER) were used in the evaluation.

As illustrated in Table 1, for example, WER of Proposed Beam-TasNet (particularly, 2 ch) is not lower than Oracle mask-MVDR (a method for estimating a spatial covariance matrix via a mask in a conventional manner). Here, Oracle mask-MVDR corresponds to upper limit performance of the conventional technique via a mask, and the proposed technique indicates that performance equivalent to the upper limit performance is achieved. In other words, it is clear that the beamformer using a spatial covariance matrix calculated by the signal processing apparatus 10a improves speech recognition accuracy of a mixed speech signal of a multi-channel.

It is conceivable that an improvement in the speech recognition accuracy described above indicates (1) an improvement in an achievable performance upper limit since the signal processing apparatus 10a does not use a mask for an estimation of a spatial covariance matrix unlike the conventional manner, and (2) performance equivalent to upper limit performance of the conventional technique for estimating a spatial covariance matrix via a mask since the signal processing apparatus 10a uses the NN 111 that directly estimates a signal in a time domain.

Further, the signal processing apparatus 10a outputs a final separated signal by using information of both of a separated signal estimated by a sound source separation technique (the NN 111) in a time domain, and a separated signal with sound of a particular sound source emphasized by the beamformer. In this way, the signal processing apparatus 10a can benefit from a merit of both techniques of the sound source separation technique in the time domain and the technique for emphasizing sound of a particular sound source by the beamformer. As a result, it is conceivable that a performance improvement when the separated signal is extracted from the mixed signal can be achieved.

Further, evaluation results when the signal correction unit 1162 outputs a separated signal based on the equation (6) in the signal processing apparatus 10a, and when the signal correction unit 1162 outputs a separated signal based on the equation (7) in the signal processing apparatus 10a are each illustrated in Table 2 below. Note that “No refinement” in Table 2 corresponds to a case where a correction by the signal correction unit 1162 is not performed, “Replaced by zeros” corresponds to a case where the signal correction unit 1162 outputs the separated signal based on the equation (6), and “Replaced by TasNet outputs” corresponds to a case where the signal correction unit 1162 outputs the separated signal based on the equation (7). An insertion error rate (IER), a deletion error rate (DER), and WER were used in the evaluation.

TABLE 2

| Method | # CH in BF | IER | DER | WER |
|---|---|---|---|---|
| No refinement | 2 | 15.2 | 0.7 | 23.7 |
| | 4 | 4.3 | 0.5 | 9.7 |
| Replaced by zeros | 2 | 3.5 | 1.8 | 15.4 |
| | 4 | 1.9 | 1.0 | 9.5 |
| Replaced by TasNet outpus | 2 | 3.9 | 0.9 | 12.5 |
| | 4 | 1.6 | 0.6 | 7.1 |

As illustrated in Table 2, for example, it is clear that IER, DER, and WER are lower when the correction by the signal correction unit 1162 is performed (when the separated signal is output based on the equation (6) or the equation (7)) than those when the correction by the signal correction unit 1162 is not performed. In other words, it is clear that the speech recognition accuracy of the mixed speech signal is further improved when the correction by the signal correction unit 1162 is performed. Furthermore, it is clear that IER is lower when the signal correction unit 1162 outputs the separated signal based on the equation (7) than that when the signal correction unit 1162 outputs the separated signal based on the equation (6). Then, as a result of reducing IER, it can be said that WER being an overall performance index is also successfully reduced. In other words, it is clear that the speech recognition accuracy of the mixed speech signal is further improved by the correction based on the equation (7) performed by the signal correction unit 1162.

Program

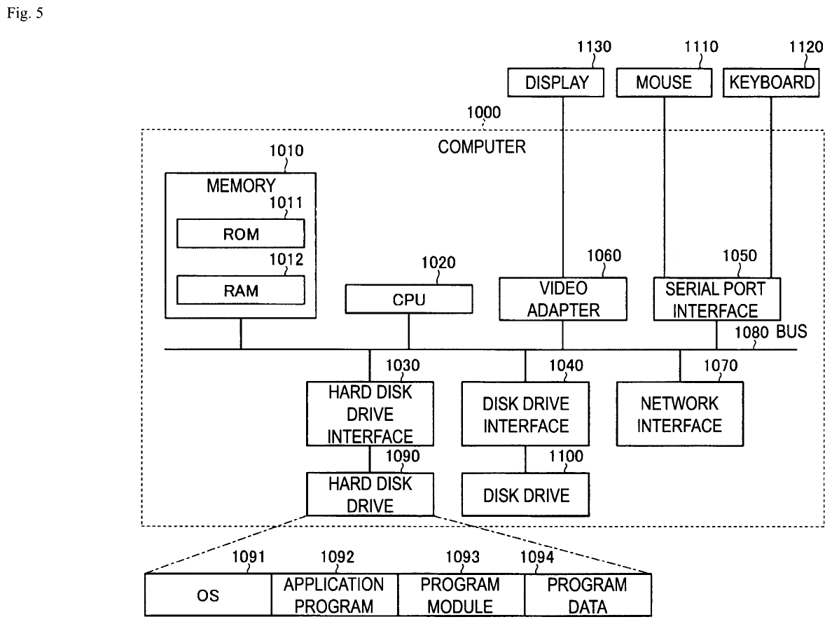

An example of a computer that executes the program described above (a signal processing program) will be described with reference to FIG. 5. A computer 1000 includes, for example, a memory 1010, a CPU 1020, a hard disk drive interface 1030, a disk drive interface 1040, a serial port interface 1050, a video adapter 1060, and a network interface 1070, as illustrated in FIG. 5. These units are connected by a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. A removable storage medium such as a magnetic disk or an optical disc is inserted into the disk drive 1100. A mouse 1110 and a keyboard 1120, for example, are connected to the serial port interface 1050. A display 1130, for example, is connected to the video adapter 1060.

Here, the hard disk drive 1090 stores, for example, an OS 1091, an application program 1092, a program module 1093, and program data 1094, as illustrated in FIG. 5. A parameter value and the like set for the NN 111 described in the aforementioned embodiment are provided in the hard disk drive 1090 and the memory 1010, for example.

The CPU 1020 reads the program module 1093 and the program data 1094, stored in the hard disk drive 1090, onto the RAM 1012 as needed, and executes each of the aforementioned procedures.

Note that the program module 1093 and the program data 1094 according to the signal processing program described above are not limited to a case where they are stored in the hard disk drive 1090 and may be stored in a removable storage medium to be read out by the CPU 1020 via the disk drive 1100 and the like, for example. Alternatively, the program module 1093 and the program data 1094 related to the program described above may be stored in another computer connected via a network such as a LAN or a wide area network (WAN) and may be read by the CPU 1020 via the network interface 1070.

### REFERENCE SIGNS LIST

10 Signal processing apparatus

111 Neural network (NN)

112 Sorting unit

113 Spatial covariance matrix calculation unit

114 Beamformer generation unit

115 Separated signal extraction unit

116 Output correction unit

1161 Speech section detection unit

1162 Signal correction unit

1. A signal processing apparatus, comprising:
a neural network configured to convert a mixed signal in which sounds of a plurality of sound sources input by a plurality of channels are mixed, into a separated signal separated into a signal for each of the plurality of sound sources as a signal in a time domain as it is, and output the separated signal;
sorting circuitry configured to sort, for the separated signal of each of the plurality of channels output from the neural network, the separated signal of each of the plurality of channels such that the plurality of sound sources of a plurality of the separated signals are aligned among the plurality of channels; and
spatial covariance matrix calculation circuitry configured to calculate a spatial covariance matrix corresponding to each of the plurality of sound sources in accordance with the separated signal for each of the plurality of channels output from the sorting circuitry and sorted.

2. The signal processing apparatus according to claim 1, further comprising:
beamformer generation circuitry configured to calculate a filter coefficient of a time-invariant beamformer in accordance with the spatial covariance matrix for each of the plurality of sound sources calculated by the spatial covariance matrix calculation circuitry; and
separated signal extraction circuitry configured to apply, to a mixed signal input, beam forming using the filter coefficient calculated by the beamformer generation circuitry to extract a separated signal in a time domain, the separated signal obtained by separating the mixed signal input for each of the plurality of sound sources.

3. The signal processing apparatus according to claim 2, further comprising:
mask information creation circuitry configured to perform detection of a speech section on a separated signal output from the neural network to create mask information for extracting a signal in a time domain corresponding to the speech section in the separated signal output from the neural network; and
signal correction circuitry configured to apply the mask information to the separated signal extracted by the separated signal extraction circuitry to extract, from the separated signal, a signal in a time domain corresponding to a speech section and output the signal extracted.

4. The signal processing apparatus according to claim 3, wherein:
the signal correction circuitry applies the mask information to the separated signal extracted by the separated signal extraction circuitry to extract, from the separated signal, a signal in a time domain corresponding to a speech section of the separated signal, and extracts, for a signal in a time domain corresponding to a silent section of the separated signal, a signal in a time domain corresponding to the silent section from the separated signal output from the neural network, and outputs the signal extracted.

5. A signal processing method, comprising:
by using a neural network trained in advance, converting a mixed signal in which sounds of a plurality of sound sources input by a plurality of channels are mixed, into a separated signal separated into a signal for each of the plurality of sound sources as a signal in a time domain as it is and outputting the separated signal;
sorting, for the separated signal of the plurality of channels output, the separated signal of each of the plurality of channels such that the plurality of sound sources of a plurality of the separated signals are aligned among the plurality of channels; and
calculating a spatial covariance matrix corresponding to each of the plurality of sound sources in accordance with the separated signal for each of the plurality of channels on which the sorting is performed.

6. A non-transitory computer readable medium including a signal processing program which when executed by a computer causes:
by using a neural network trained in advance, converting a mixed signal in which sounds of a plurality of sound sources input by a plurality of channels are mixed, into a separated signal separated into a signal for each of the plurality of sound sources as a signal in a time domain as it is and outputting the separated signal;
sorting, for the separated signal of the plurality of channels output, the separated signal of each of the plurality of channels such that the plurality of sound sources of a plurality of the separated signals are aligned among the plurality of channels; and
calculating a spatial covariance matrix corresponding to each of the plurality of sound sources in accordance with the separated signal for each of the plurality of channels on which the sorting is performed.
